(19) United States
(12) Patent Application Publication
(10) Pub. No.: US 2016/0153574 A1
(43) Pub. Date: Jun. 2, 2016

(54) BALL VALVE WITH AN IMPROVED SEAT RING

(71) Applicant: ROTEX MANUFACTURERS AND ENGINEERS PRIVATE LIMITED, Dombivali East (IN)

(72) Inventors: AJIT KOTHADIA, Mumbai (IN); AMIT SHAH, Mumbai (IN)

(21) Appl. No.: 14/582,218

(22) Filed: Dec. 24, 2014

(30) Foreign Application Priority Data
Nov. 27, 2014 (IN) 3970/MUM/2014

(51) Int. Cl. F16K 25/00; F16K 5/06

(52) U.S. Cl. CPC F16K 25/005; F16K 5/0663

(57) ABSTRACT

A ball valve (100) with an improved design of a seat ring (20), the ball valve (100) has a valve body (106) with a ball (102) disposed in a central passage (104) of the valve body (106). The ball (102) has a bore (103) through it for communicating with an inlet port (111) and an outlet port (112) of the present at ends of the central passage (104) of the ball valve (100). A pair of seat ring (20) is provided in the central passage (104) on opposite sides of the ball (102). An improved valve seat ring (20) consists of generally a conical structure having dominantly three surfaces—a dynamic surface (22), a static surface (24) and a free surface (26). There is provided a back cavity (28) which is open from the free surface (26). The dynamic surface (22) transitions from a convex profile to a near flat profile to a concave profile which facilitates a wide pressure band of operation of this ball valve with improved seat ring (20). Construction of back cavity (28) reduces mass and consequently the thermal influence on sealing reliability.

### FIELD OF INVENTION

The present invention relates to valves used for controlling flow of fluids, particularly valves which use a ball, and are thus commonly referred to as ball valves. More particularly, this invention relates to a seat ring, also known as a seal, used for preventing undesired fluid seepage or leakage within a ball valve.

### BACKGROUND OF INVENTION

A ball valve is a valve having a spherical ball that controls the flow through it. The spherical ball has a through path or bore, which, when is co-axial with the inlet and outlet port of the valve leads to opening of the valve, allowing the flow to occur. In the closed position, the through path or bore is substantially at right angle with the inlet and outlet port of the valves. The ball valve could be either a trunnion ball valve or a floating ball valve.

Between the body of the valve and the ball is provided a seal to prevent the leakage of the fluid when the valve is closed. A seal is also called as a seat ring because it sits on the valve, and is generally of the shape of a ring. The direction in which flowing fluid approaches the ball is generally known as an upstream while the direction away from the ball, along which a flowing fluid leaves the valve, is known as a downstream.

In a trunnion ball valve, the ball is anchored on bearing or on pivot whereas its seals float. The seals in the trunnion valve are externally energized using springs. As the seal floats under fluidic pressure the upstream seal presses against the ball and it is therefore active, while the downstream seal is inactive. Floating ball valve in which the ball floats and the seal is just held in the body, the seals are self-energizing. As the ball floats under fluidic pressure the downstream seal is active while the upstream seal is inactive.

In both the cases, whether trunnion ball valve or floating ball valve, the main requirements are that:
Effective positive sealing under wide operating fluidic pressure
Reduced wear
Higher seal life
Reduced actuating torque to operate ball valve

The design of the profile of seal or seat ring is crucial to achieve this primary functional requirement. Considering than the ball is generally convex in shape, the corresponding surface of seal is, often, concave. Alternatively, one uses a convex seal which theoretically has a point contact with the ball, but in reality, there is a definite contact surface area generated, which increases with the fluid pressure. The stress generated consequently in the seal is known as Hertzian Contact Stress.

U.S. Pat. No. 8,201,574 B2 (Beasley) discloses a bidirectional sealing for a Ball Valve. Referring to FIG. 1 therein, the ball valve is placed between an end adapter having a sealing surface and a first seat having a sealing surface placed on a seat holder. The first seat has a bias mechanism placed in the groove of the seat holder. The bias mechanism controls the compression of the first seat to a particular extent. The placement of the seats and the sealing action in the upstream direction (U) and downstream direction (D) in the ball valve assembly allows the valve to be functional in both the directions. The sealing concept here is essentially a concave-convex seal, which means that the seal takes a concave shape over the ball which is convex. This kind of pairing is also known as conforming pair.

U.S. Pat. No. 4,126,295 (Natalizia) discloses a metal seat for ball valve with top entry non spherical type. As shown in FIG. 2, the metal seat has a U shaped cylindrical structure having a soft metal region on its surface. The surfaces of the ball valve merely engage with the soft metal regions, thus providing a sealing with leakage proof. The legs of the seat in contact with the valve body provided support to prevent the metal seat from collapsing. The metal used in the soft metal region should be soft enough so as to not cause damage to the ball after repeated rotations. The seal is in principle a conforming seal.

U.S. Patent Publication No. 2013/0299730 A1 (Hills et al.) discloses a valve seat for ball valve wherein the seat has a continuous curved convex surface profile on its front surface and the rear surface. The convex profile of the seat is claimed to allow the stresses incurred during the loading of the ball valve to widely and evenly distribute throughout the structure of the seat. This is an example of a convex-convex seal or a non-conforming seal.

European Patent Publication No. 0027048 (Calvert) discloses a seal for trunnion ball valve made for conducting an inflammable fluid. A graphite ring is fitted between the frusto-conical portion and the adjacent peripheral wall of the housing and a first spacer ring is located between the graphite ring and the shoulder. An annular pressure plate is located between the end face of the seal member and the spring means and has an annular lip abutting the graphite ring. A second spacer ring is provided between the end face of the seat member and the pressure plates. This is a special application for preventing the spread of fire through inflammable liquid.

U.S. Patent Publication No. 2012/0112110 (Lewandowski et al.) discloses the ball valve seat seal. The ball valve has an angled wall with a first groove for accommodating a first seal and a second groove for accommodating a second seal. The angled wall increases the contact with the ball thus increasing the sealing efficiency. The first seal and the second seal have a different Young's Modulus.

U.S. Pat. No. 7,311,118 (Doutt) discloses a seat for floating ball valve working at a range of pressures. The seat has a radius larger than the radius of the ball valve with seat material and geometry such that the seat is self-compensational during changes in temperature and pressure. The seat has a concave profile with interacts with the convex profile of the ball valve, in other words it is a conforming seal.

U.S. Pat. No. 4,750,708 (Yusko) discloses a seat for floating ball valve able to sustain changes in pressure and temperature of the flowing fluid. The ball valve has a seat member includes an outer circumferential rim portion and a radially inward extending frusto-conical portion. The spherical sealing surface of the seat has a radius equal to the radius of the ball. The sealing surface (70) is not described to be conforming or non-conforming.

Many of the above patents even though claiming to be operating at various pressures do not completely disclose the difference in the profile of the seal at different pressures.

The known art merely uses seal as an obstruction and does not go at length towards an inventive solution in consonance with fluid flow. Most seals offer high friction, resulting in wear and excessive operating torque. There is also known a seal with cavity behind but such a seal compromises on the fundamental functioning as shall be elaborated subsequently.

Our invention addresses this and discloses a seal design which effectively works for a wide pressure and temperature range.

### OBJECTIVE OF THE INVENTION

The main objective of the invention is to provide a ball valve with a seal or a seat ring that provides positive sealing under high operating fluidic pressure.

Another objective of the invention is to provide a seat that can provide positive sealing up to 200° C. fluidic temperature.

Yet another objective of the invention is to ensure a minimum operating torque.

Yet another objective of the invention is to provide least seat wearing and thus increase seat life.

Yet another objective is to invent a seal that absorbs and accommodates larger manufacturing variations in assembly.

### SUMMARY OF THE INVENTION

A ball valve with improved seat ring has a valve body with a ball disposed in a central passage of the valve body. The ball has a bore through it for communicating with an inlet port and an outlet port present at two ends of the central passage of the ball valve. An improved seat ring is provided in the central passage on either side of the ball—one seat ring is on an upstream side and another seat ring is on a downstream side.

The cross-section of the valve seat ring is generally a conical structure, and is formed by dominantly three surfaces at angles. The three surfaces consist of a dynamic surface, a static surface and a free surface. The valve seat also has an annular depression, termed as a back cavity, which is open from the free surface. Additionally, there is a first concave surface and a second concave surface, having identical radius of curvature.

The static surface of the seat ring is in contact with the valve body and forms a body sealing surface of the ball valve. The static surface has a radial contact with the valve body. This surface is responsible to prevent a body leakage.

The free surface of the seat ring is a supporting surface. The free surface has an axial contact with the valve body. The free surface of the seat ring in contact with the valve body is responsible to hold the seat ring in position in the valve body.

The dynamic surface of the seat is in contact with the ball and thus forms the ball sealing surface. The dynamic surface in contact with the ball has an active region which is flexible. The shape of the dynamic surface changes from being a convex surface to a concave surface on the downstream side under fluidic pressure. The dynamic surface is responsible to prevent a fluid leakage with respect to the ball surface of the ball in the valve close position.

The seat ring is assembled in the valve body with a pre-compression.

The back cavity is absence of material thereby creating a hollow depression all around the seat ring, thus can also be understood by the term annular depression. The back cavity is open from the free surface such that an active region, thus created is a cantilever. By forming the back cavity, considerable amount of material is avoided, which if present, would just add unwanted mechanical rigidity and material cost.

Due to the back cavity the seat ring flexes and can accommodate higher manufacturing variations without causing ball leakage, neither excessive contact stress.

Our inventive seat ring is made of known materials, like Polytetrafluoroethylene, abbreviated as PTFE. PTFE and such polymers have more than ten times the coefficient of thermal expansion of steel, of which the ball of the valve is made. Therefore, the more the mass of the material used for a valve seat, the more is the thermal deformation of the seat relative to the ball and other parts of the valve, and the more likelihood of a seal failure because of variation in sealing pressure with temperature. Construction of back cavity reduces mass and consequently the thermal influence on sealing reliability. Consequently, the valve with improved seat ring is operable at wider temperature range, of the order of minus 50 degrees up to 200 degrees centigrade, subject to other suitability.

The dynamic surface of the valve seat ring forms a variable Non-Conforming rolling surface having a circular line as a point of contact called as a micro annular area, thus forming a “Higher Kinematic Pair”. The dynamic surface is deformable due to back cavity and selected material. A convex-convex rolling contact surface i.e. between the dynamic surface of the valve seat ring and the ball surface provides a required sealing pressure at the low fluidic pressure. As the fluidic pressure increases, a contact force increases, increasing an micro annular area of the dynamic surface by deformation, thereby maintaining the Hertzian contact stress or pressure thus friction torque, resulting into controlling the wearing of seat and improved life of the seat ring.

When the ball valve is in use for controlling the fluid flow, the situation for the seat ring at the upstream side is different than the situation at the downstream side, in the valve close position.

For the ball valve with a floating ball, the pressured fluid pushes the ball towards the seat ring on the downstream side. Consequently, the ball gets pushed away from the seat ring on the upstream side and the pressure with which the dynamic surface of the seal seat was originally resting on the ball reduces. On the upstream side the pressure of the fluid further pushes the seat ring on its first concave surface and overcomes the reduced pressure exerted by the seat ring on the ball from its dynamic surface. Consequently, the dynamic surface of the first seat ring flexes and gives way to the fluid. The back cavity allows the active region of the seat ring to flex backwards.

The seat ring on the downstream side provides sealing between the ball surface of the ball of the ball valve and valve body of the ball valve. On the downstream side, the pressured fluid enters the back cavity through the free surface and reinforces the pressure exerted by the dynamic surface on the ball of the ball valve, and the pressure exerted by the static surface on the valve body of the ball valve, fluid pressure being represented by multiple arrows.

As the fluid pressure rises, the dynamic surface of the second seat ring gets pushed more and more by the fluid from within the back cavity as well as directly from upstream side. Consequently, the dynamic surface transitions from a convex profile to a near flat profile to a concave profile, whence the concave profile is in conformity with the convex profile of the ball of the ball valve.

As the dynamic surface such transitions, the first concave surface and the second concave surface of the second seat ring, which was hitherto non-functional till the dynamic surface was a convex profile, now become functional and provide an augmented surface with larger area for sealing, resulting in effective conforming sealing.

As the fluid pressure is rises, the ball gets slightly pushed towards the second seat ring, and the ball in turn pushes back the dynamic surface of the second seat ring. Consequently, and since the active region is a cantilever, the point of contact between the ball surface and the dynamic surface of the seat ring shifts down towards the axis of flow and value of an angle α reduces. This reduction in the value of the angle α causes reduction in the operating torque.

In other words, as the fluidic pressure rises, the dynamic surface of the seat ring dynamically changes from a convex profile to a concave profile maintaining a sealing with relatively small contact pressure on the ball at all the time, and the ball valve with this improved seat ring is capable of operating at a wider pressure band.

The back cavity helps in increasing the effectivity of the second seat ring on the downstream side, while at the upstream side, the back cavity results into flexibility of the active region due to which the seat ring on the upstream side results in negligible frictional torque with the surface of the ball.

The above mentioned static surface of the seat ring provides sealing action against the valve body and thus the surface area of the static surface ought to be maximized. In a prior art seat ring, the cavity behind results in compromising the surface area of the static surface(s) and valve tends to be leaky from the valve body.

As can be ascertained, the improved design of seat ring is suitable for upstream side as well as downstream side, and therefore, subject to other constructional constraints, a ball valve with improved seat ring as per this disclosure is suitable for using reversibly, that is, the inlet port and outlet port are interchangeable and the ball valve with improved seat ring as per this invention can be connected in a fluid circuit using either of its port as the inlet or the outlet port.

### BRIEF DESCRIPTION OF DRAWINGS

FIG. 1A shows the front view of an improved seat ring.

FIG. 1B shows a cross section of the improved seat ring, taken along a section line B-B.

FIG. 1C shows a magnified view of a section of the improved seat ring.

FIG. 2 shows a ball valve with a ball in a valve body, the seat ring on the either side of the ball, its inlet and outlet ports and an upstream/downstream side

FIG. 3A shows the ball and seat rings when the valve is in a closed condition.

FIG. 3B shows the ball and seat rings when the valve in an open condition.

FIG. 3C shows the diagonal distance between a dynamic surface of the two seat rings; and the width of the ball of the ball valve, for explaining their relation.

FIG. 4A shows a section of the first seat ring, which is on the upstream side, when the ball valve is in a close position.

FIG. 4B shows a section of the second seat ring, which is on the downstream side, when the ball valve is in a close position.

FIG. 5 shows the transitioning of the dynamic surface of the second seal from a convex profile to a near flat profile to a concave profile and a relative shift in a point of contact.

FIG. 5A shows the change in angle α consequent to change in the point of contact between the ball surface and the dynamic surface of the seat ring.

FIG. 6 shows a prior art seat ring

FIG. 7 exhibits a micro annular area formed due to Hertzian Contact Stress.

### DETAILED DESCRIPTION OF INVENTION

### Definitions

Static describes an application in which there is no relative motion between the mating surfaces. Thus a Static sealing is one which works in an environment where no relative motion exists between the mating surfaces.

Dynamic describes an application in which the two mating surfaces to be sealed are in a relative motion with respect to each other.

Conforming Contact is when two surfaces fit exactly or closely together without deformation.

Non-Conforming Contact is when the surfaces or one of the two surfaces deforms when there is a contact area in between them.

Rolling Contact is a contact between bodies such that the relative velocity of the two contacting surfaces at the point of contact is zero.

The preferred embodiment of our invention will now be described in detail, with reference to the accompanying drawings. The terms and expressions which have been used here are merely for description but the invention can be worked with several variations and the terms and expressions should not be construed to be limiting the invention in any way.

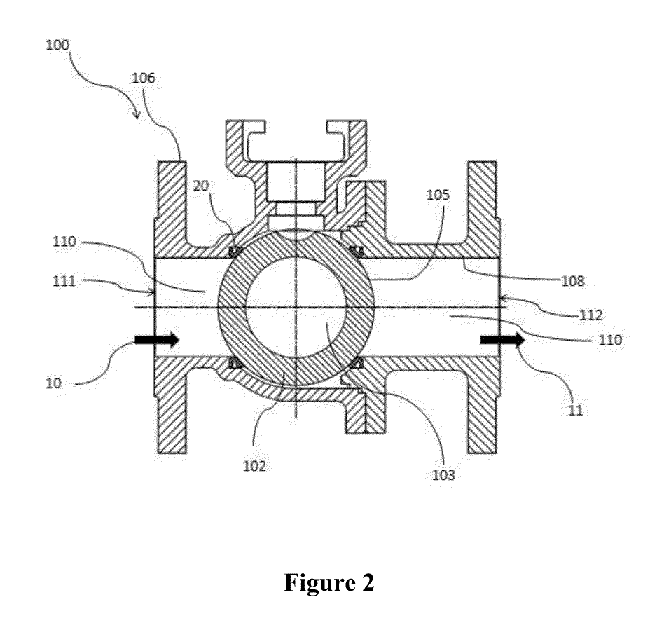

FIG. 2, illustrates a ball valve (100). The ball valve (100) has a valve body (106) with a ball (102) disposed in a central passage (110) of the valve body (100). The ball (102) has a bore (103) through it for communicating with an inlet port (111) and an outlet port (112) present at two ends of the central passage (110) of the ball valve (100). An improved seat ring (20) is provided in the central passage (110) on either sides of the ball (102)—one seat ring (20) is on an upstream side (10) and another seat ring (20) is on a downstream side (11). The seat rings (20) along with the ball (102) are enclosed within the valve body (106), along with other components not described here, to form a ball valve (100).

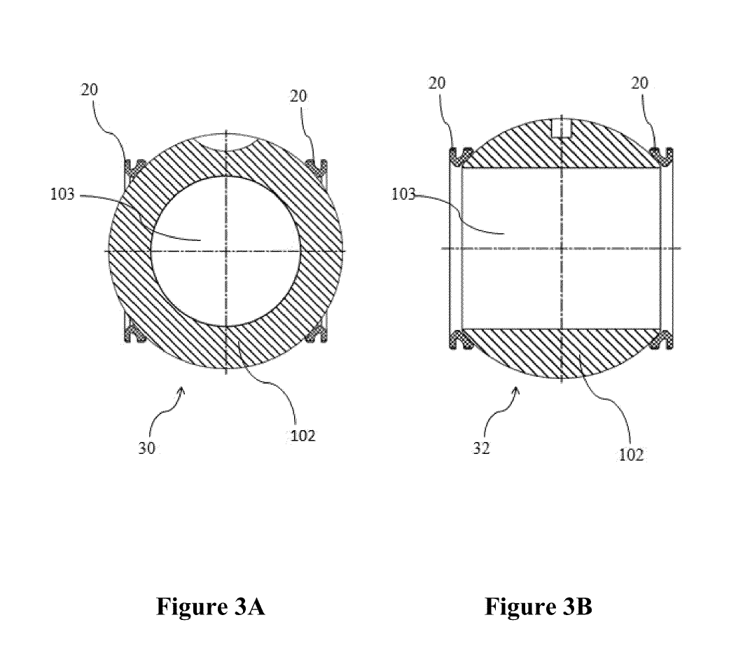

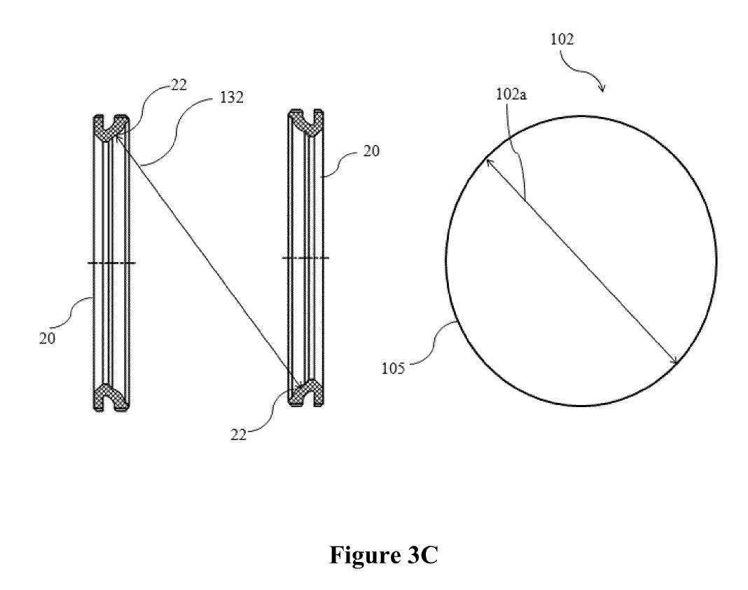

As shown in FIG. 3A and FIG. 3B, read along with FIG. 2, the ball (102) is mounted in the valve body (106) between the two seat rings (20), one seat ring (20) on either side, such that the ball (102) can selectively rotate between a valve closed positions (30) and a valve open position (32). In the valve closed position (30), the bore (103) of the ball (102) is at right angle with the central passage (110) of the ball valve (100) as shown in FIG. 3A. In the valve open position (32), the bore (103) of the ball (102) is co-axial with the central passage (110) of the valve body (100) such the fluid can flow from the inlet port (111) to the outlet port (112), from the upstream side (10) to the downstream side (11) referring to FIG. 3B.

As is known, a positive sealing needs an optimal contact stress between the ball surface (105) of the ball (102) and the seat ring (20), just higher than a fluidic pressure. A magnitude of the contact stress between the ball (102) and the seat ring (20) depends on an area of the surfaces in contact under the force. The contact stress is given by—

(σ_{c})=F/A
Where (σ_{c})=Contact stress
F=Force
A=Contact area

For a given force (F), the optimal contact stress is obtained by controlling the contact area (A). An improved seat ring (20) as per this disclosure has a dynamic surface which results into controlled contact area as optimally needed, corresponding to the fluidic pressure.

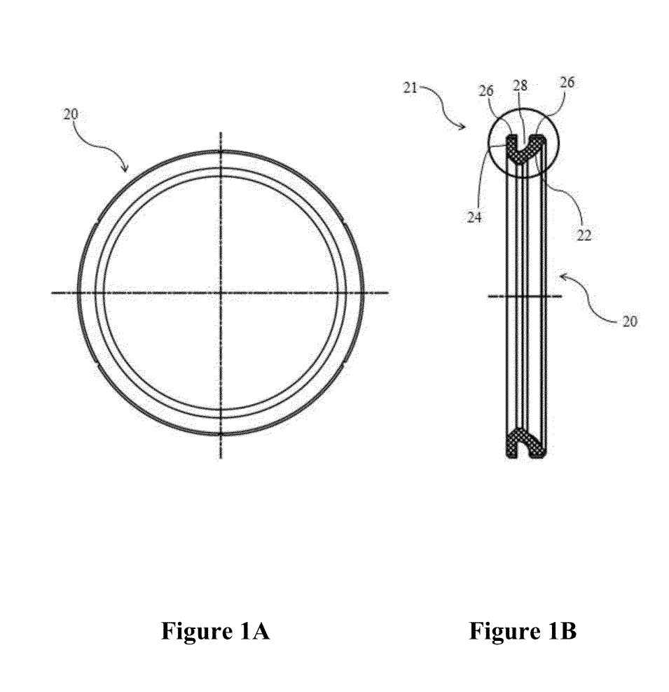

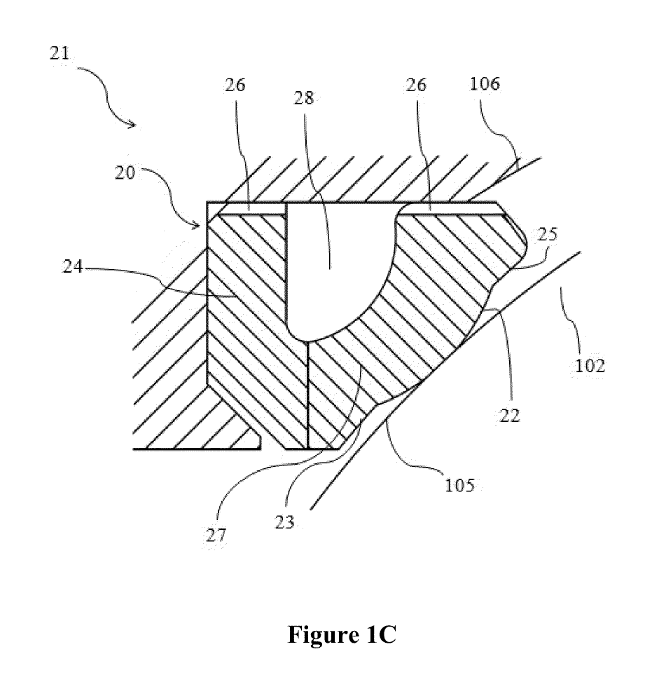

Referring to FIG. 1A, illustrates an improved valve seat ring (20), FIG. 1B being a sectional view of FIG. 1A taken along line B-B, and the FIG. 1C being a magnified section (21) with reference to the valve body (106) and the ball (102). The section (21) of the valve seat ring (20) is generally a conical structure, and is formed by dominantly three surfaces at angles. The three surfaces consist of a dynamic surface (22), a static surface (24) and a free surface (26). The valve seat also has an annular depression, termed as a back cavity (28), which is open from the free surface (26).

The static surface (24) of the seat ring (20) is in contact with the valve body (106) and forms a body sealing surface of the ball valve (100). The static surface (24) has a radial contact with the valve body (106). This surface is responsible to prevent a body leakage.

The free surface (26) of the seat ring (20) is a supporting surface. The free surface (26) has an axial contact with the valve body (106). The free surface (26) of the seat ring (20) in contact with the valve body (106) is responsible to hold the seat ring (20) in position in the valve body (100).

The dynamic surface (22) of the seat (20) is in contact with the ball (102) and thus forms the ball sealing surface. The dynamic surface (22) in contact with the ball (102) has an active region (27) which is flexible. The shape of the dynamic surface (22) changes from being a convex surface to a concave surface on the downstream side (11) under fluidic pressure, which will be explained in the later part. The dynamic surface (22) is responsible to prevent a fluid leakage with respect to the ball surface (105) of the ball (102) in the valve close position (30).

In the improved valve seat ring (20), a high contact stress is formed and maintained between the dynamic surface (22) and the ball (102), whereas an intermediate contact stress is formed and maintained on its static surface (24), which is just enough for static sealing in valve body (106); and a low contact stress on its free surface (26) which is required for sliding the supporting surface within the valve body (106).

The seat ring (20) is assembled in the valve body with a pre-compression. As shown in FIG. 3C, this implies that a diagonal distance (132) between the dynamic surface (22) of one of the seat ring (20) and the dynamic surface (22) of the other seat ring (20) is smaller than the width (102a) of the ball (102), so that the dynamic surface sits on the ball surface (105) under stress, known as Hertzian Contact Stress. Persons skilled in the art are well aware that there are inevitable dimensional variations during manufacturing, howsoever small. Such dimensional variations, depending on the magnitude and positivity or negativity of difference between the diagonal distance (132) and the width (102a), impact the product performance, which in this case could either be a leakage at the ball surface (105) at some pressure, or it could be excessive Hertzian Contact stress at the dynamic surface (22) resulting into wear at the dynamic surface (22) or excessive torque requirement for operating the valve, resulting in reduced life of the ball valve (100). If a higher pre-compression force is applied it resists the free motion of the ball (102) resulting in a higher frictional torque, and if an actuator (not shown in the drawings) is to be used to operate the valve, then a higher than optimal size actuator is necessitated to drive the ball valve (100). A unique shape and appropriate material of the seat ring (20) can avoid the higher than optimal pre-compression force required to be applied, and thus increase the durability and the seat life.

The back cavity (28) introduced in the seat ring (20) addresses this problem. The back cavity (28) is absence of material thereby creating a hollow depression all around the seat ring, thus can also be understood by the term annular depression. The back cavity is open from the free surface (26) such that an active region (27) thus created, is a cantilever. By forming the back cavity (28), considerable amount of material is avoided, which if present, would just add unwanted mechanical rigidity and material cost.

Due to the back cavity (28) the seat ring (20) flexes and can accommodate higher manufacturing variations without causing ball leakage, neither excessive contact stress.

Our inventive seat ring (20) is made of known materials, like Polytetrafluoroethylene, abbreviated as PTFE, and which is suitable for such applications. PTFE is a fluorocarbon solid synthetic fluoropolymer of tetrafluoroethylene. PTFE and such polymers have more than ten times the coefficient of thermal expansion of steel, of which the ball (102) of the valve (100) is made. Therefore, the more the mass of the material used for a valve seat, the more is the thermal deformation of the seat relative to the ball (102) and other parts of the valve (100), and the more likelihood of a seal failure because of variation in sealing pressure with temperature. Construction of back cavity (28) reduces mass and consequently the thermal influence on sealing reliability. Consequently, the valve (100) with improved seat ring (20) is operable at wider temperature range, of the order of minus 50 degrees up to 200 degrees centigrade, subject to other suitability.

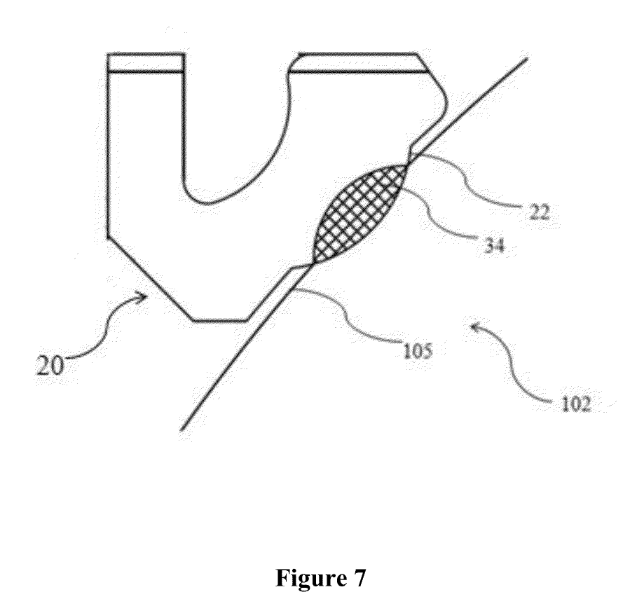

The dynamic surface (22) of the valve seat ring (20) forms a variable Non-Conforming rolling surface having a circular line as a point of contact called as a micro annular area (34), as shown in FIG. 7, thus forming a “Higher Kinematic Pair”, a term known to persons skilled in the art. The dynamic surface (22) is deformable due to back cavity (28) and selected material. A convex-convex rolling contact surface i.e. between the dynamic surface (22) of the valve seat ring (20) and the ball surface (105) provides a required sealing pressure at the low fluidic pressure. As the fluidic pressure increases, a contact force increases, increasing an micro annular area (34) of the dynamic surface (22) by deformation, thereby maintaining the Hertzian contact stress or pressure thus friction torque, resulting into controlling the wearing of seat and improved life of the seat ring (20).

When the ball valve (100) is in use for controlling the fluid flow, the situation for the seat ring (20) at the upstream side (10) is different than the situation at the downstream side (11), in the valve close position. To describe the inventiveness of improved seat ring (20), the seat ring (20) on upstream side (10) shall be described as a first seat ring (201) and the seat ring (20) on the downstream side shall be described as a second seat ring (202).

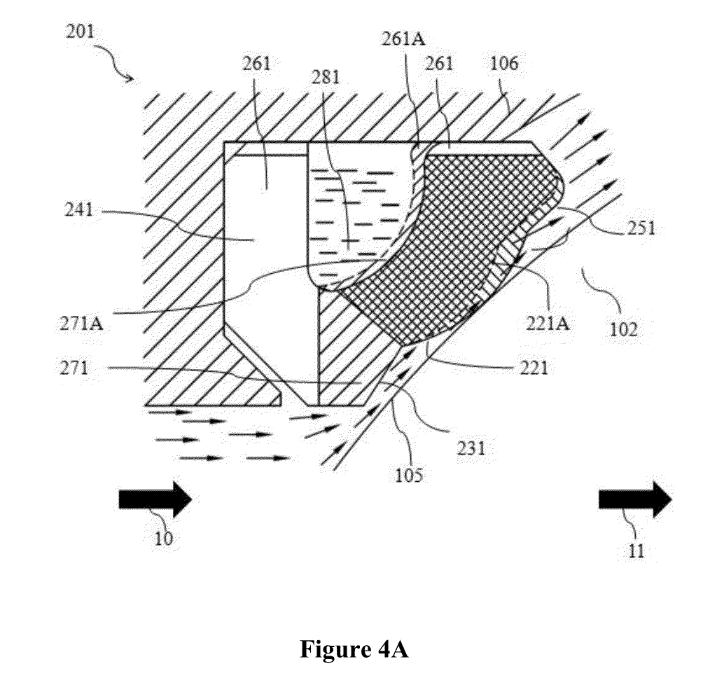

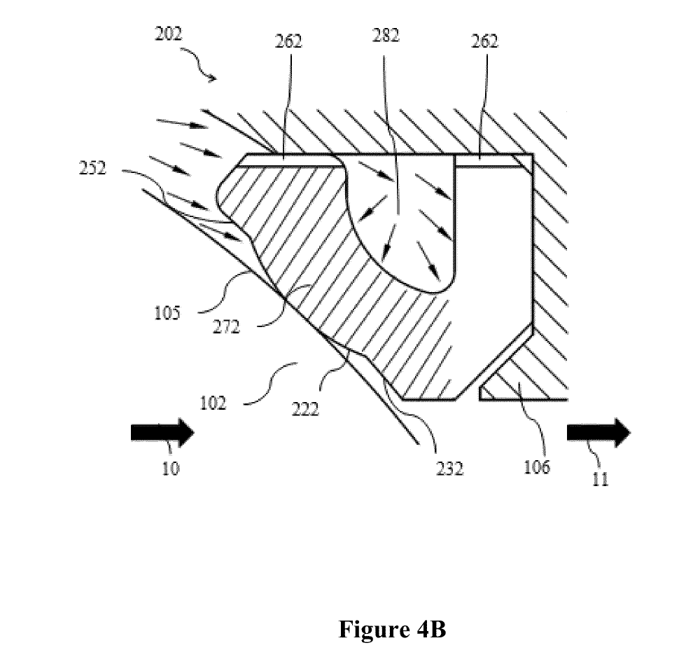

As shown in FIG. 4A, the first seat ring (201) has a dynamic surface (221), a static surface (241), a free surface (261) and a back cavity (281). There is a first concave surface (231) and a second concave surface (251), having identical radius of curvature.

As shown in FIG. 4B, the second seat ring (202) has a dynamic surface (222), a static surface (242), a free surface (262) and a back cavity (282). There is a first concave surface (232) and a second concave surface (252), having identical radius of curvature.

As shown in FIGS. 4A and 4B, read along with FIG. 2, for the ball valve (100) with a floating ball, the pressured fluid pushes the ball (102) towards the seat ring (202) on the downstream side (11). Consequently, the ball (102) gets pushed away from the seat ring (201) on the upstream side (10) and the pressure with which the dynamic surface (221) of the seal seat (201) was originally resting on the ball (102) reduces. On the upstream side (10) the pressure of the fluid further pushes the seat ring (221) on its first concave surface (231) and overcomes the reduced pressure exerted by the seat ring (201) on the ball (100) from its dynamic surface (221). Consequently, the dynamic surface (221) of the first seat ring (201) gives way to the fluid, as indicated by multiple arrows. The back cavity (281) allows the active region (271), shown as hatched area, of the seat ring (201) to flex backwards as shown by a double hatched area, consequently the dynamic surface (221a) and the free surface (261a).

The seat ring (202) on the downstream side (11) provides sealing between the ball surface (105) of the ball (102) of the ball valve (100) and valve body (106) of the ball valve (100). On the downstream side (11), the pressured fluid enters the back cavity (282) through the free surface (262) and reinforces the pressure exerted by the dynamic surface (222) on the ball (102) of the ball valve (100), also the pressure exerted by the static surface (242) on the valve body (106) of the ball valve (100), fluid pressure being represented by multiple arrows, thereby improving the sealing.

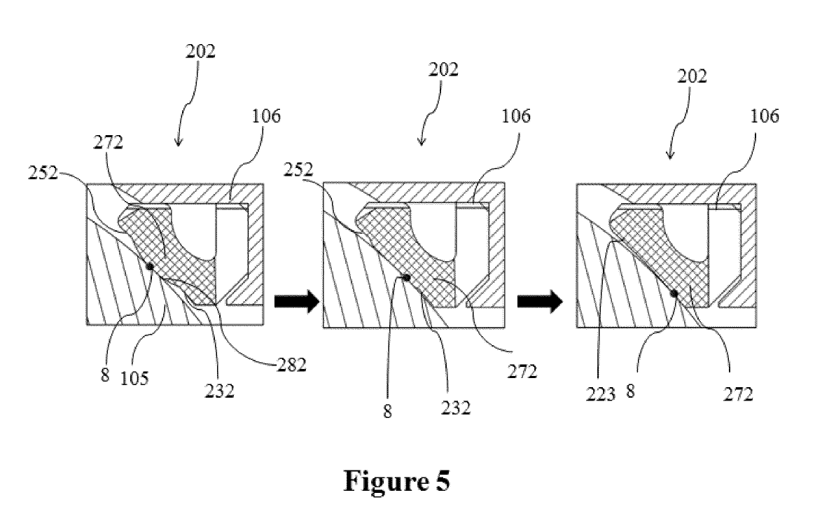

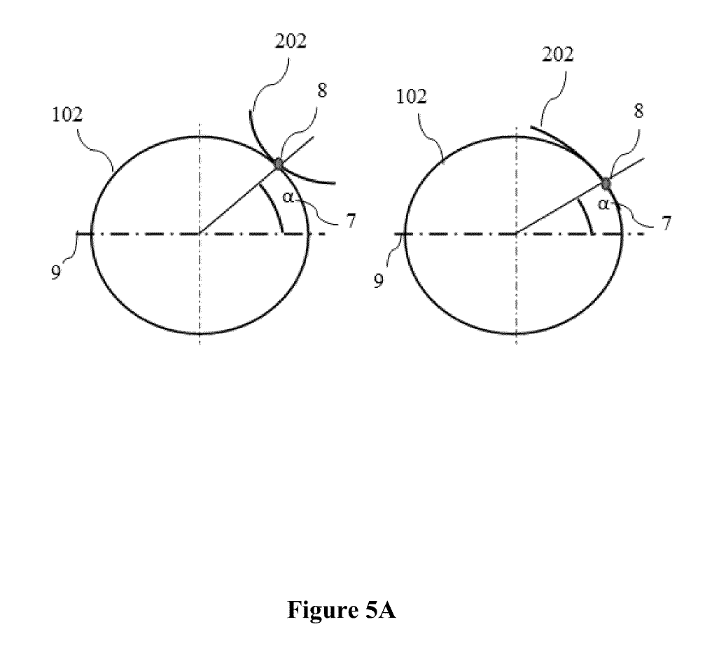

As the fluid pressure rises, the dynamic surface (222) of the second seat ring (202) gets pushed more and more by the fluid from within the back cavity (282) as well as directly from upstream side (10). Consequently, the dynamic surface (222) transitions from a convex profile to a near flat profile to a concave profile, whence the concave profile is in conformity with the convex profile of the ball of the ball valve. FIG. 5 illustrates this transition.

As the dynamic surface such transitions, the first concave surface (232) and the second concave surface (252) of the second seat ring (202), which was hitherto non-functional till the dynamic surface was a convex profile, now become functional and provide an augmented surface (223) with larger area for sealing, resulting in effective conforming sealing.

As shown in FIG. 5 and FIG. 5A, as the fluid pressure is rises, the ball (102) gets slightly pushed towards the second seat ring (202), and the ball (102) in turn pushes back the dynamic surface (282) of the second seat ring (202). Consequently, and since the active region (272) is a cantilever, the point of contact (8) between the ball surface (105) and the dynamic surface (282) of the seat ring (202) shifts down towards the axis of flow (9) and value of an angle α (7) reduces. This reduction in the value of the angle α (7) causes reduction in the operating torque.

In other words, as the fluidic pressure rises, the dynamic surface (222) of the seat ring (202) dynamically changes from a convex profile to a concave profile maintaining a sealing with relatively small contact pressure on the ball (102) at all the time, and the ball valve (100) with this improved seat ring is capable of operating at a wider pressure band.

The back cavity (282) helps in increasing the effectivity of the second seat ring (202) on the downstream side (11), while at the upstream side (10), the back cavity (281) results into flexibility of the active region (271) due to which the seat ring (201) on the upstream side results in negligible frictional torque with the surface of the ball (102).

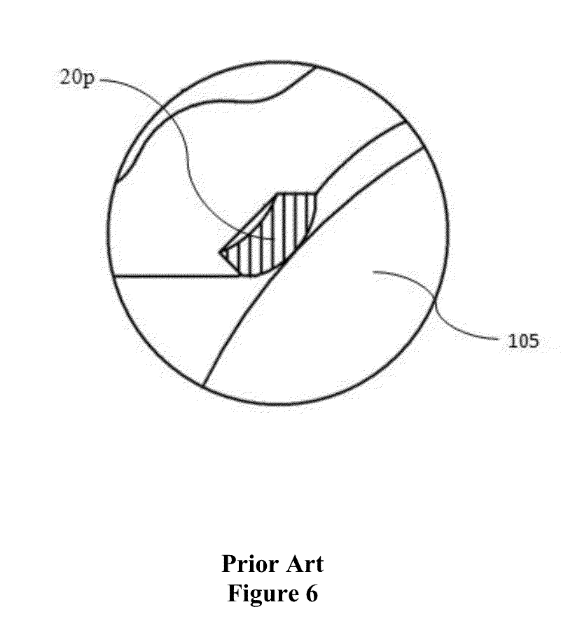

The above mentioned static surface (24) of the seat ring (20), as also the static surface (241) of the first seat ring (201) and also the static surface (242) of the second seat ring (202) provides sealing action against the valve body (106) and thus the surface area of the static surface (24, 241, 242) ought to be maximized. In a prior art seat ring (20p) shown in FIG. 6, the cavity behind results in compromising the surface area of the static surface(s) and valve tends to be leaky from the valve body.

As can be ascertained, the improved design of seat ring (20) is suitable for upstream side (10) as well as downstream side (11), and therefore, subject to other constructional constraints, a ball valve (100) with improved seat ring (20) as per this disclosure is suitable for using reversibly, that is, the inlet port (111) and the outlet port (112) are interchangeable and the ball valve (100) with improved seat ring (20) as per this invention can be connected in a fluid circuit using either of its port as the inlet port or the outlet port.

The term valve and ball valve has been used interchangeably hereinabove.

The invention has been described with reference to the preferred embodiment. Obviously, modifications and alterations will occur to others upon a reading and understanding of this specification. It is intended to include all such modifications and alterations insofar as they come within the scope of the appended claims or the equivalents thereof.

We claim:

1) A ball valve with an improved seat ring, comprising of a valve body with a ball disposed in a central passage; the ball having a through bore for communicating with an inlet port and an outlet port, present at two ends of the central passage; a seat ring provided in the central passage on either side of the ball—a first seat ring on an upstream side and a second seat ring on a downstream side, characterized in that:
the seat ring has a conical structure, formed by dominantly three surfaces at angles, comprising of:
i. a dynamic surface in contact with a surface of a ball and placed in the ball valve;
ii. a static surface in contact with a surface of the valve body of the ball valve;
iii. a free surface in contact with the surface of the valve body holding the seat in a position in the ball valve;
iv. a back cavity which is open from the free surface; and
v. a first concave surface and a second concave surface
the seat ring is assembled in the valve body with a pre-compression such that a diagonal distance between the dynamic surface of the first seat ring and the dynamic surface of the second seat ring is smaller than a width of the ball, so that the dynamic surface sits on the ball surface under Hertzian Contact Stress.

2) The ball valve with the improved seat ring as claimed in claim 1, wherein the back cavity is open from the free surface such that an active region thus created is a cantilever.

3) The ball valve with the improved seat ring as claimed in claim 2, wherein the active region and the dynamic surface of the seat ring flexes under fluid pressure on the upstream side.

4) The ball valve with the improved seat ring as claimed in claim 1, wherein the dynamic surface is deformable.

5) The ball valve with the improved seat ring as claimed in claim 1, wherein the second seat ring on the downstream side provides sealing between the surface of the ball and the valve body of the ball valve.

6) The ball valve with the improved seat ring as claimed in claim 1, wherein on the downstream side, the pressured fluid enters the back cavity through the free surface and reinforces the pressure exerted by the dynamic surface on the ball of the ball valve.

7) The ball valve with the improved seat ring as claimed in claim 1, wherein on the downstream side the pressured fluid enters the back cavity through the free surface and reinforces the pressure exerted by the static surface on the valve body of the ball valve.

8) The ball valve with the improved seat ring as claimed in claim 1, wherein the dynamic surface transitions from a convex profile to a near flat profile to a concave profile as fluid pressure rises.

9) The ball valve with the improved seat ring as claimed in claim 1, wherein the first concave surface and the second concave surface on the second seat ring on the downstream side provides an augmented surface when the dynamic surface transitions to a concave profile.

10) The ball valve with the improved seat ring as claimed in claim 1, wherein the ball gets slightly pushed towards the second seat ring as the fluid pressure rises, the ball in turn pushes back the dynamic surface of the second seat ring, a point of contact between the ball surface and the dynamic surface of the seat ring shifts down towards the axis of flow and value of an angle α reduces, which causes reduction in an operating torque.

11) The ball valve with the improved seat ring as claimed in claim 1, wherein the ball valve with the improved seat ring is suitable for using reversibly such that the inlet port and outlet port are interchangeable.

12) The ball valve with the improved seat ring as claimed in claim 1, wherein the ball valve with the improved seat ring is usable for a fluid pressure range of vacuum to 1000 bar.

13) The ball valve with the improved seat ring as claimed in claim 1, wherein the ball valve with the improved seat ring is usable for a fluid temperature range of minus 50 degrees centigrade up to 200 degrees centigrade.
